(19) United States
(12) Patent Application Publication
(10) Pub. No.: US 2015/0213651 A1
(43) Pub. Date: Jul. 30, 2015

(54) OUTDOOR, INTERACTIVE 3D VIEWING APPARATUS

(71) Applicant: Aaron SELVERSTON, San Francisco, CA (US)

(72) Inventor: Aaron SELVERSTON, San Francisco, CA (US)

(21) Appl. No.: 14/682,969

(22) Filed: Apr. 9, 2015

Related U.S. Application Data
(63) Continuation-in-part of application No. PCT/US2014/059696, filed on Oct. 8, 2014.
(60) Provisional application No. 61/889,441, filed on Oct. 10, 2013.

(51) Int. Cl. G06T 19/00; G02B 23/18; H04N 13/04; G02B 27/22

(52) U.S. Cl. CPC G06T 19/006; G02B 27/22; G02B 23/18; H04N 13/0429

(57) ABSTRACT

An outdoor, interactive 3D viewing apparatus has a head assembly, a yoke assembly and a base assembly. The head assembly includes a back face and a front face, the front face including an eyepiece area, buttons and a face lock to secure the front face to the back face. The yoke assembly supports the head assembly and includes yoke arms, handle circles, a yoke base, a yoke post, yoke sleeve and post bearings. The base assembly has a base pipe with a top collar fitted into it, a base step over a lower collar all sitting atop a foot base that sits on a durable surface.

### TECHNICAL FIELD

The present invention relates generally to apparatuses for viewing a scene, and more particularly to viewing an internal scene that shows an image.

### BACKGROUND

Binocular viewing devices are popular at scenic outlooks and parks. One presses one's face against the device and positions the eyes to see through the two lenses. Then one focuses the lenses to produce a view of what is in front of the viewer. These devices are limited to adjusting and viewing a location immediately adjacent to the viewing device.

### SUMMARY

In one embodiment, there is provided a viewing apparatus having a) a head assembly with a back face and a front face, the front face comprising an eyepiece area, buttons and a face lock to secure the front face to the back face; b) a yoke assembly to support the head assembly, the yoke assembly comprising yoke arms, a yoke base, handle circles, a yoke post, yoke sleeve and post bearings; and c) a base assembly comprising a base pipe with a top collar fitted into it to attach the yoke assembly, a base step over a lower collar all sitting atop a foot base that sits on a durable surface.

Alternatively, the base step has adjustable supports to level the base step. The yolk post fits into post bearings that reside in the yoke sleeve. The head assembly has two holes in its sides to accommodate handles. The eyepiece area has no lens. The viewing apparatus has handles which adjust the head to provide panning and tilting.

In another embodiment, a 3D viewing apparatus has a) a head assembly with a back face and a front face, the front face having an eyepiece area, buttons and a face lock to secure the front face to the back face; b) a yoke assembly to support the head assembly, the yoke assembly having yoke arms, a yoke base, handle circles, a yoke post, yoke sleeve and post bearings; a base assembly with a base pipe with a top collar fitted into it to attach the yoke assembly, a base step over a lower collar sitting atop a foot base that sits on a durable surface; a top step to enable shorter persons to look in the eyepiece; and a custom printed circuit board inside the head, the circuit board interfacing with a set of peripherals and with a computer.

In other embodiments, the peripherals include a microphone, a speaker, a sensor, a video display, a plurality of owl lights, or a combination thereof. Alternatively, the 3D viewing apparatus has at least one handle. The handle has at least a handle axle, at least one trigger, at least one underlying trigger switch to convey impulses to the computer and/or circuit board. The handle further has a trigger cover to protect the trigger and trigger switch from the elements.

In yet another embodiment, there is provided a method of viewing a future development in 3D the method. This method begins with a) providing 3D viewing apparatus having i) a head assembly including a back face and a front face, the front face ha an eyepiece area, buttons and a face lock to secure the front face to the back face; ii) a yoke assembly to support the head assembly, the yoke assembly with yoke arms, a yoke base, handle circles, a yoke post, yoke sleeve and post bearings; iii) a base assembly with a base pipe with a top collar fitted into it to attach the yoke assembly; iv) a base step over a lower collar all sitting atop a foot base that sits on a durable surface; v) a top step to enable shorter persons to look in the eyepiece; and vi) a custom printed circuit board inside the head, the circuit board interfacing with a set of peripherals and with a computer. Next steps include loading the computer and/or custom printed circuit board with a set of computerized images of a plurality of planned appearances of a location; setting the viewing apparatus in a location adjacent the location of the future development; and securing the viewing apparatus to a hard surface.

### BRIEF DESCRIPTION OF THE DRAWINGS

Referring to the drawings:

FIG. 1 is a front view of an embodiment of the viewing apparatus, showing the head assembly, yoke assembly and the base assembly;

FIGS. 2A-2F show comparative views of the viewing apparatus, including the front (FIG. 2A), the right side (FIG. 2B), the back (FIG. 2C), the left (FIG. 2D), the bottom (FIG. 2E) and the top (FIG. 2F);

FIG. 3 shows a partially exploded close-up of the front view of the head assembly with the yoke assembly;

FIG. 4 is a partially exploded, tangential view of the head assembly, with the two buttons, face lock and the handles shown separate from the basic head assembly;

FIG. 5 is an exploded view of the yoke assembly showing the different parts, including attachment to the base;

FIGS. 6A, 6B and 6C show the base components. FIG. 6A shows the base; and FIG. 6B shows the step base separately from the pole and base. FIG. 6C shows supports for the step base;

FIG. 7 is an overview of an additional embodiment.

FIGS. 8A-8F show respectively a front view (FIG. 8A), a side view (FIG. 9B), a back view (FIG. 8C), a view of the other side (FIG. 8D), a top view (FIG. 8E) and a bottom view (FIG. 8F);

FIG. 9 is an exploded view of the head assembly with handle and yoke assemblies.

FIGS. 10A-10F are various views of the components of the handle and its axle.

FIG. 11 is an exploded view of the yoke and axle of the viewing apparatus;

FIG. 12 is an exploded transverse view of the head assembly showing the arrangement of the components thereof; and

FIG. 13 is an exploded transverse view of the base assembly of the viewing apparatus.

### DETAILED DESCRIPTION

I have invented a viewing apparatus to “look into the future.” I designed the waterproof shell of the viewing apparatus to be eye-catching enough to attract people to a geographic site to take a look in the eyepiece(s). Then the user discovers that he can look at how a particular geographic site will look in the future after the plans are executed. With such an apparatus, more architects and builders are able to show their customers and interested members of the public what their early-stage ideas will look like in the future. To my knowledge this is the first such outdoor, interactive 3D experience.

For example, the city of San Francisco held a series of public workshops to share design options for the future “Better Market Street” project. The options were complicated and hard to visualize without the high-quality visualizations that would ordinarily cost $50,000 to $100,000. My team and I worked on designing a 3D model of an eye-catching display device and created unique views. The visualization was highly informative and the public experienced an improved visualization at a much earlier stage.

We provide a pedestal-mounted waterproof case that provides rotation, panning and tilting for the purposes of viewing and manipulating content displayed on a video display housed within the case. The pedestal-mounted apparatus provides interfaces such as handles and buttons that the viewer can use to virtually rotate, pan and tilt the content displayed within the apparatus so as to create an augmented or virtual reality user experience. This virtual reality device provides a fully immersive viewing experience similar to that of conventional virtual reality systems, but at a fraction of the usual cost. This virtual reality device is publicly accessible and designed to obtain and record the opinions of its users. For outdoor use, the device is weatherized and robust to public use, which takes 3D visualization in a new direction and vastly expands its audience.

The main functions of the virtual reality device include user-controlled pan-tilt of internal motion-tracking sensors thereby controlling and changing views of a virtual reality. The two buttons or other controls are accessible on the front of the pedestal-mounted case permit the user to control a computer application on a computer tablet mounted inside the case. These controls enable the views to change and provide the sensation of rotating, panning and tilting. The pan-tilt control influences a gyroscope within the tablet mounted inside the case to give the effect of moving an actual 3D object on the video display. And finally, the two-button pan-tilt controls a virtual reality environment displayed on a video display inside the case. A computer tablet is beneficial for this outdoor use; however, when the system is water-tight, a mini-computer with attached accelerometer, gyroscope, rotational sensors and/or compass is provided with an external display. For different ways to provide these features, see below and Example 1.

Application processes on the computer tablet include, but are not limited to, 1) spherical, panoramic images display using the KRPano graphics engine and/or another rendering graphics engine, such as the Unity gaming platform; 2) a menu that depicts thumbnail images of each model; and 3) menu navigation via control by key commands via an external input device such as the two buttons, a keyboard, etc.

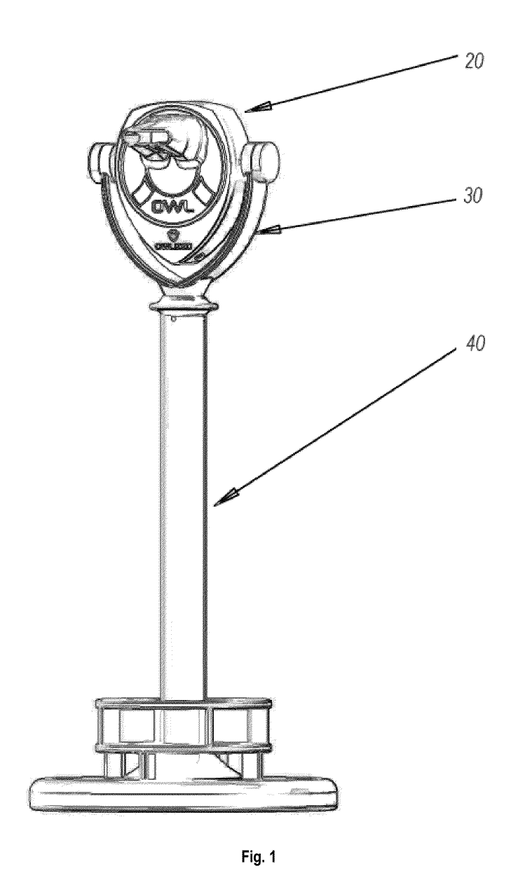

Referring now to FIG. 1, this first model of the viewing apparatus 10 has a waterproof head assembly 20, a yoke assembly 30 and a base assembly 40. Inside the head assembly 20 is a computer with monitor for viewing through the eyepiece, preferably a small tablet (not shown). Besides a tablet computer, a small computer can be used to power an augmented video display or a stereoscopic video display. There are at least two ways to display 3D images: 1) tablet having native 3D video display and 2) stereoscopic two screen video display with lens and visor. The exposed parts of the viewing apparatus (described in more detail below) are preferably made of machined or cast metal. Preferably steel and aluminum are used for the head assembly, although plastic or other durable materials can also be used.

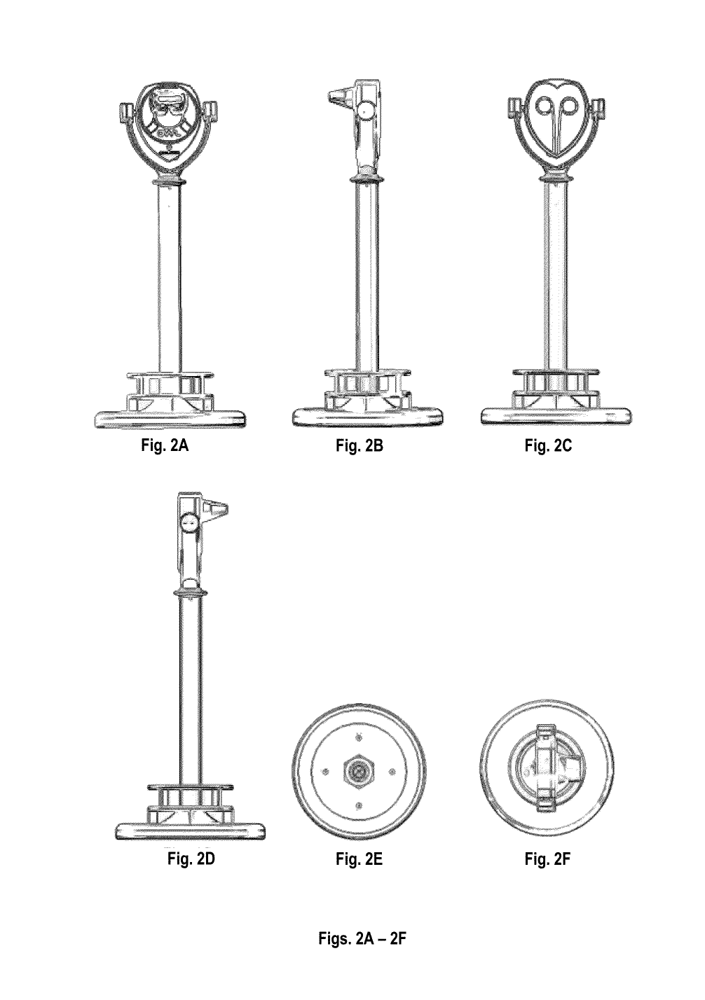

FIGS. 2A-2F represent all sides of one embodiment of the viewing apparatus.

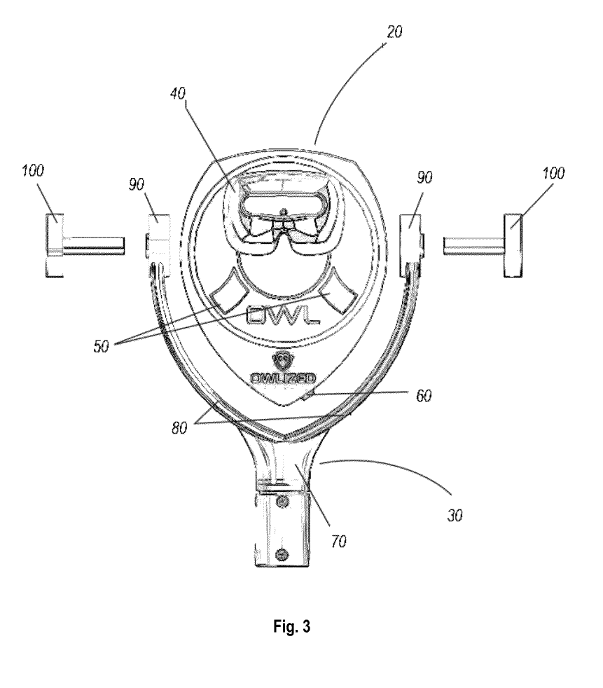

FIG. 3 shows the front of the head assembly 20 with spaces between it and the yoke assembly 30 for better understanding. The head assembly 20 has an eyepiece area 40 through which an individual can view a computer monitor or tablet screen (not shown). The eyepiece need not have a magnifying lens, as the image is produced on a computer monitor. On the front of this head assembly 20 are two buttons 50 that an individual can press to pan, rotate and tilt an image displayed inside. Additional buttons can be used to provide more functions or to separate the functions to individual buttons. The front of the head assembly 20 is opened to insert a computing device with a monitor, preferably a tablet (not shown), which can be viewed. To keep passersby from opening the head assembly, the head assembly 20 has a face lock 60. In other embodiments, the head assembly 20 is equipped with a microphone, speakers, audio inputs and outputs, or any combination thereof. The head assembly 20 or the base assembly 40 is optionally equipped with a USB port that has a connection to the inside computer and is used to communicate with and to power the computer. The connections between the buttons 50 and the tablet computer (not shown) are hardwired or wireless, such as a BLUETOOTH connection. Alternately, the buttons 50 are replaced with other useful control devices, including but not limited to joy sticks.

FIG. 3 further shows the yoke assembly 30, which has a yoke assembly base 70 and two yoke arms 80. The yoke arms 80 encircle the lower part of the head assembly and end in right and left handle circles 90 next to the sides of the head assembly 20. Two handles 90 are positioned on either side of the head assembly 20 and the yoke 40. The handles 90 extend through the handle circles 90 and into holes (not shown) in the sides of the head assembly 20 where the handles 90 are affixed to the head assembly, thereby supporting the head assembly 20 and permitting the user to adjust the angle of the front of the head assembly 20 to the user's height and gaze through the eyepiece area 40. Alternately, the handles 90 can be used to tilt the head assembly 2D and to change the view within the head assembly 20.

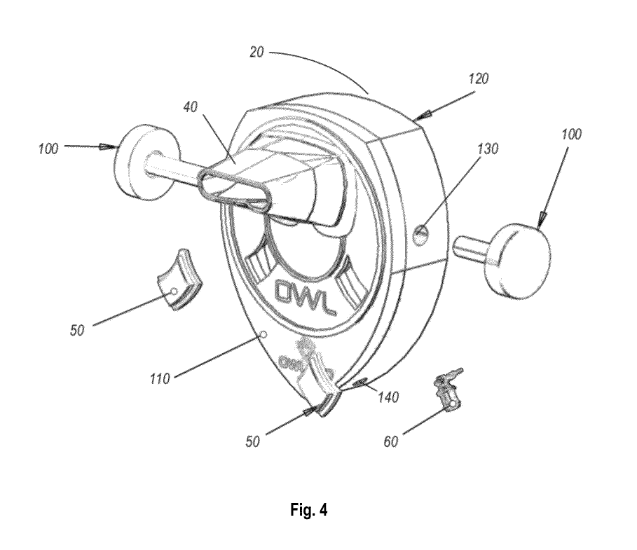

FIG. 4 is a transverse view of the head assembly 20 and the eyepiece area 40. The front face 110 is now visible with the demarcation around the side. The back face 120 wraps around the side and has a hole 130 for the handle 100. The two buttons 50 are shown in front of the head assembly. In one embodiment, the buttons 50 are inserted from the inside of the front face 110 and are spring loaded (not shown) to respond to user pressure to pan or tilt. The face lock 60 is shown near its hole 140 on the side of the head assembly 20.

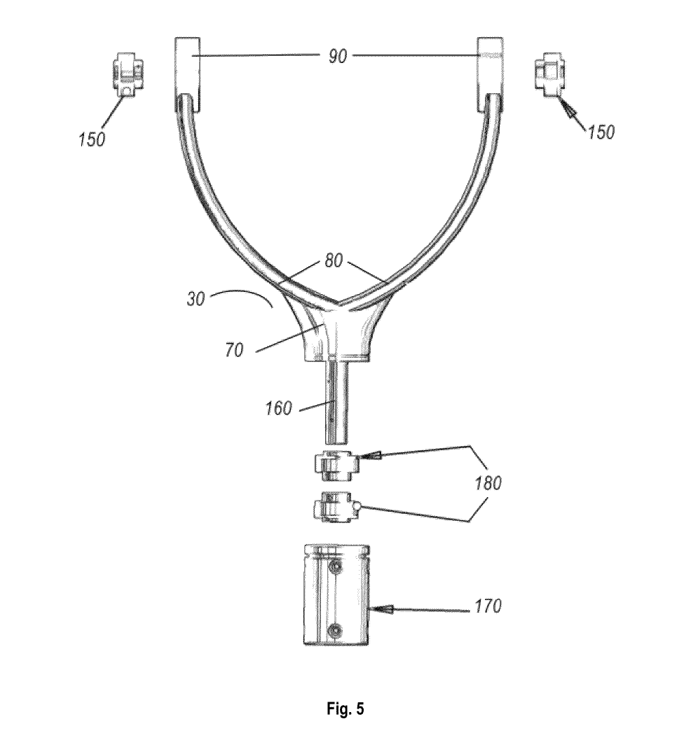

FIG. 5 is an exploded view of the yoke assembly 30. It shows one embodiment in which there is a one-piece yoke with yoke base 70, yoke arms 80 with distal handle circles 90 and a yoke post 160. Inside the handle circles 90 are handle bearings 150 that position and support the handles (not shown). In this embodiment, the yoke assembly 30 attaches to the base assembly 40 through a yoke post 160 and yoke sleeve 170.

Here the yoke post 160 is surrounded and supported by two post bearings 180 that fit into the yoke sleeve 170 and permit the yoke assembly 30 to be turned as much as 360°.

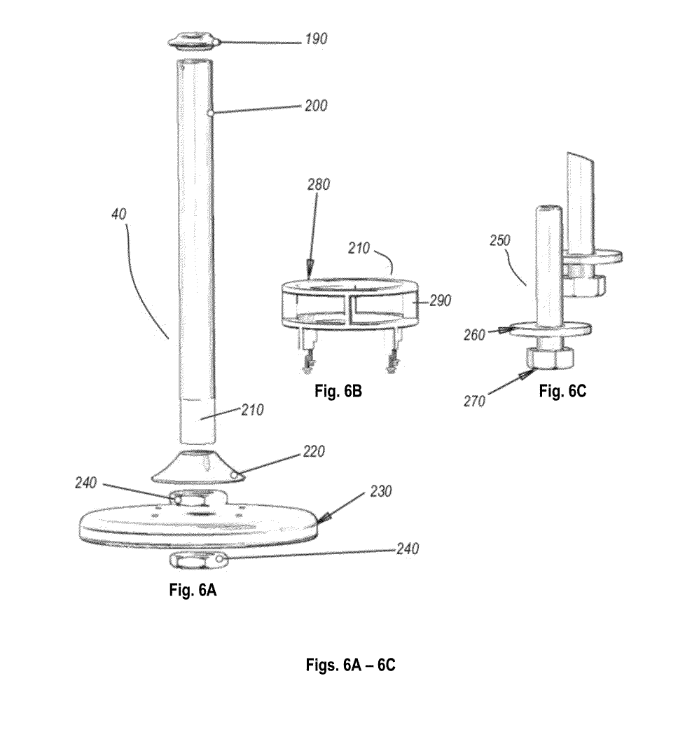

FIG. 6A is an exploded view of one embodiment of the base 40. At the top is a top collar 190 to shield the connection with the yoke assembly 30. The top collar 190 is placed above and fits into the base pipe 200 and may be screwed in place for greater durability. The base pipe 200 passes through base step 210 (shown as a shadow in FIG. 6A and in more detail in FIG. 6B). The base pipe 200 also passes through lower collar 220 to rest on or pass through pipe bearing 240. Pipe bearings 240 are on top and/or under foot base 230, which can be connected to any durable surface such as wood or concrete (not shown).

FIG. 6B shows detail of one embodiment of the base step 210 with at least one ring 280 for shorter people to stand on. When there are two or more step rings 280 in the base step 210, they are separated and supported by at least one strut 290. The base step can be molded as a single piece. The base step is further supported as indicated by A (shown in more detail in FIG. 6C).

FIG. 6C shows the detail of one embodiment of the step support rods 250. Their height can be adjusted via the support washer 270 to make sure that the viewing assembly is truly vertical, regardless of the angle of the surface on which the foot base sits. To protect the support washer 270 from the elements or unintended changes, the support washer 270 is covered by washer 260.

To use the invention, the user holds the head assembly handles 100 with two hands to adjust and tilt the head assembly 20 up and down and right to left and—uniquely—to move the image displayed on the monitor correspondingly. The user presses the right and left buttons 50 that interface with the internal computer to control a software application on the computer. In one embodiment, the user holds the head assembly 20 with two hands while placing thumbs on the left and right buttons 50.

### EXAMPLE 1

This updated model includes surprising new features. First, the base is different, with an added top step for shorter persons to stand on and more readily access the viewer. Second, the base itself is a larger flat surface for added stability. A new custom printed circuit board provides interfaces between the peripherals and the laptop to enable more efficient and complex data handling and displays. The peripherals include, but are not limited to, computer, laptop, microphone, sensors, video display, speaker, owl eye lights, etc.

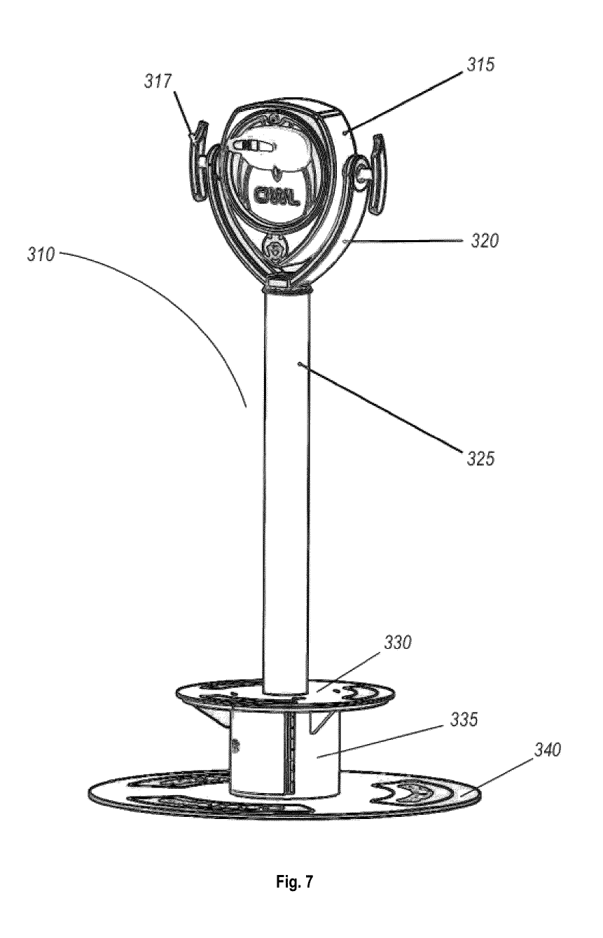

Referring now to FIG. 7, an overview of the new model, the viewing apparatus 310 has a head assembly 315, a supporting yoke assembly 320, a handle assembly 317, a wider base assembly 325, a new wider top step 330, a broader support under the top step 335, and a wide flat base 340.

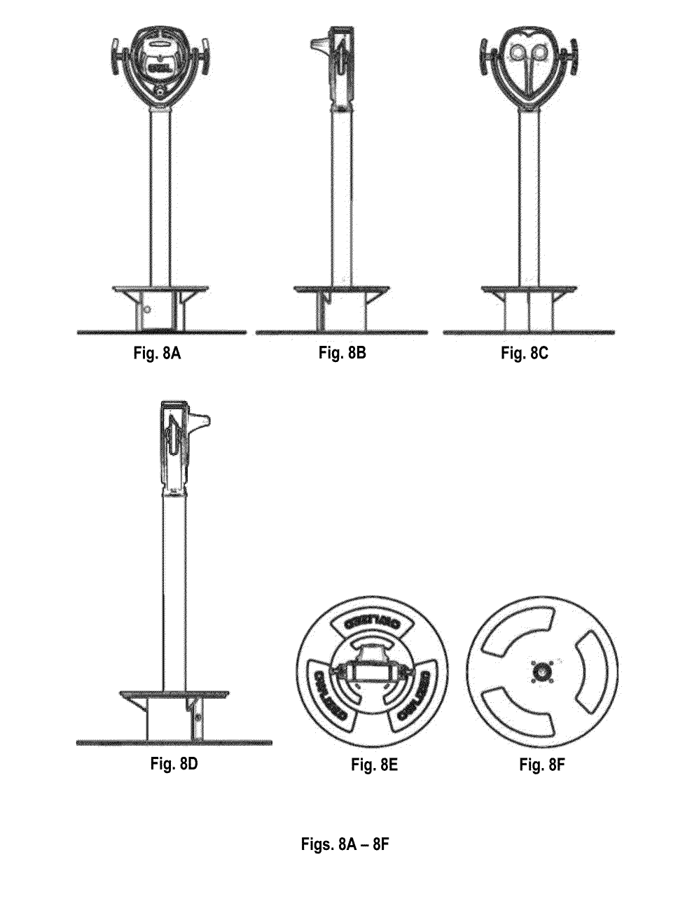

FIGS. 8A-8F represent all sides of the new embodiment of the viewing apparatus 310.

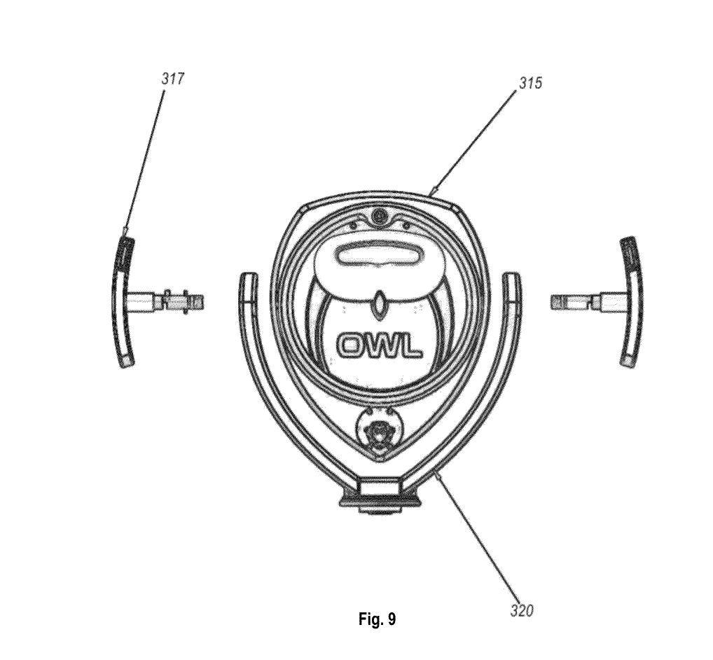

FIG. 9 shows an exploded view of the new model's front of the head assembly 315 with yoke assembly 320 and handle assembly 317.

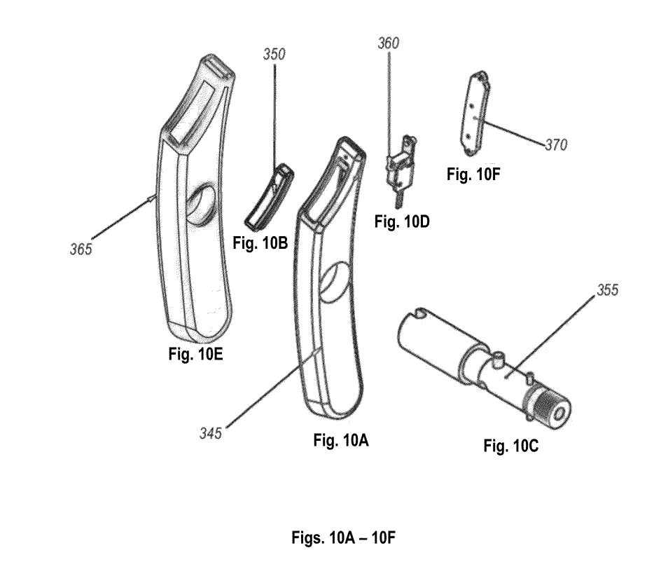

The new handle assembly 317 is shown in more detail in FIGS. 10A-10F. FIG. 10A shows the handle 345 with an indentation 347. FIG. 10B shows a trigger 350 that fits into the top of the handle 345. FIG. 10C shows the handle axle 355, one end of which fits into the handle indentation 347, and the other end that fits into the head assembly 315 side. Both triggers provide hold, receive and release data which are used to in part control the software, like the buttons on a video game controller. FIG. 10D shows a trigger switch 360 that underlays the trigger 350 and connects to the custom circuit board (not shown). FIG. 10E shows an embodiment of a handle cover 365 to protect the handle 345 from the elements. FIG. 10F shows a trigger cover 370 that also protects the operative mechanism—the trigger 350—from the elements. This handle assembly 317 differs from the earlier model in that there is an active trigger 350 here; whereas, the prior assembly included only a handle to tilt the head assembly.

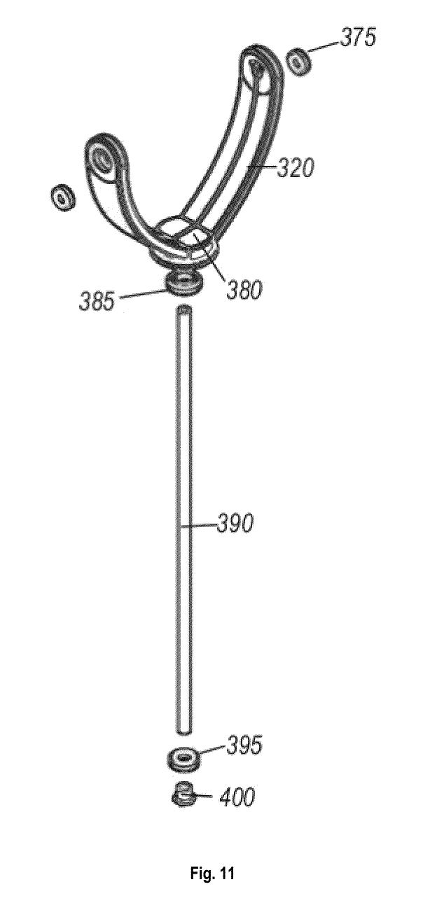

Proceeding now to the new axle/base assembly shown in FIG. 11, we see the yoke assemble 320 with its handle bearing 375 on either side of the yoke 320. The two sides of the yoke 320 are attached to the central neck 380. Immediately beneath the central neck 380 is the top axle bearing 385, which attaches to the axle 390 of the base assembly as shown in FIG. 7. At the bottom of the axle 390 is a bottom hex bolt 395, into which the bottom axle bearing 400 fits.

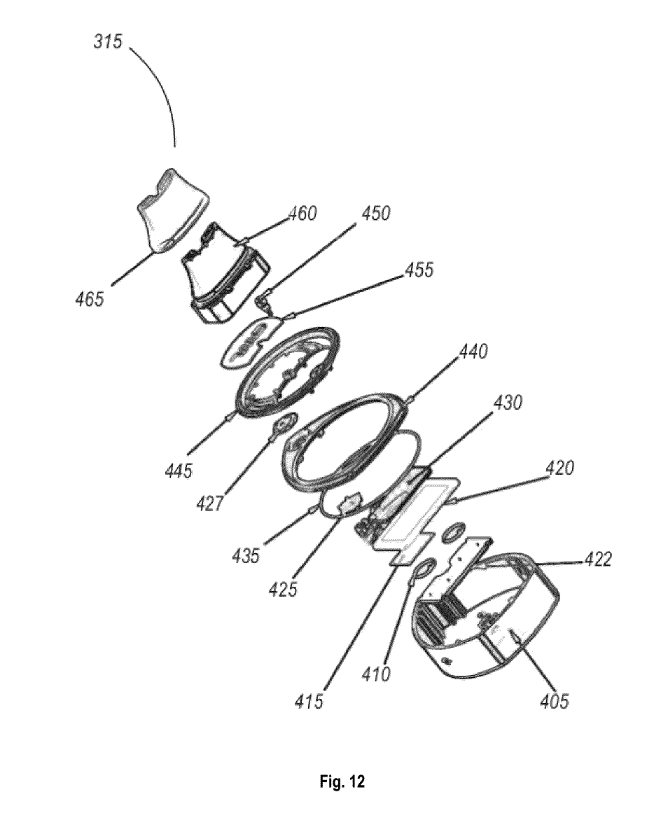

FIG. 12 is an exploded view of the new waterproof head assembly 315. Starting at the lower right of FIG. 12, we see the front housing 405 which has the owl face. The LED owl eyes 410 insert into the front housing holes. Behind the owl eyes 410 is the custom printed circuit board 415, to which the owl eyes 410 and other peripherals connect. Adjacent is the computer tablet 420 that also connects to the circuit board 415. The computer tablet 420 can be replaced by a programmable CPU and display. Adjacent these components is a speaker assembly 425, which is covered with a speaker cover plate 427. Overlaying the electronics is the viewfinder glass 430, which is sealed in place with O-ring 435 and the rear owl housing 440 which attaches to the front housing 405 via a hinge (not shown). Overlaying the rear owl housing 440 is a rear housing door 445 with lock 450. Optionally the head assembly has a name plate 455. Attached in a recess of the rear housing 440 and rear housing door 445 is a viewfinder 460 on which the observer places her forehead to block ambient light. The viewfinder 460 has a viewfinder overmold 465 that protects the viewfinder 460 from the elements.

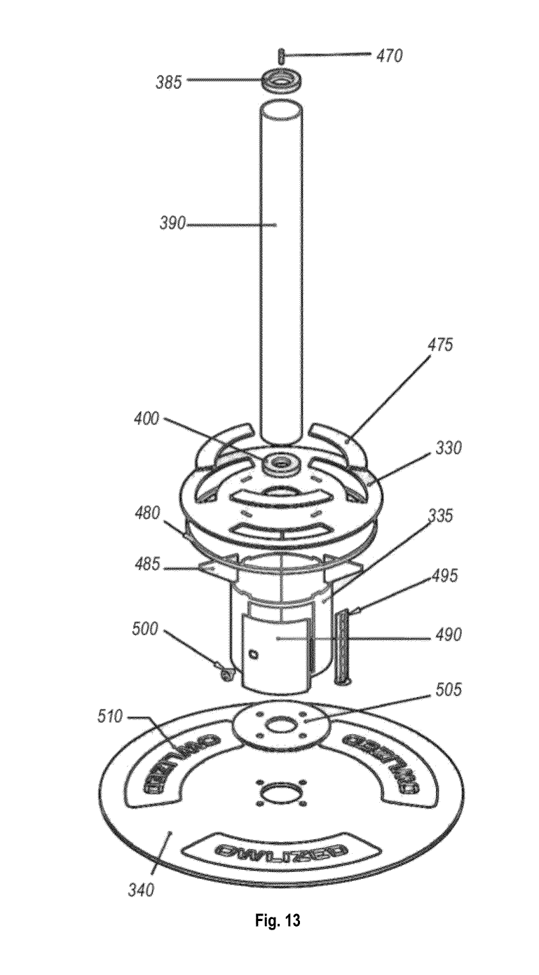

FIG. 13 is an exploded view of the new base of the apparatus. Starting at the top is a bushing pin 470 to connect to the supporting yoke assembly 325 and the upper bearing 385 sitting atop the axle or pole 325. At the bottom of the pole 325 is lower bearing 400. One embodiment of the top step 330 is shown with optional top step inserts 475, in this case made of acrylic. To reinforce the top step 330 there is an optional flange 480, surrounding the edge of the top step 330. As further support for the top step 330, there is support housing 335, with support wings 485 extending therefrom to support the top step sides. The support housing 335 also has the housing door 490 with hinge 495 and lock 500. Under the support housing 335 is a mounting plate 505 which sits on the flat base 340. Threaded studs (not shown) are installed in the bottom surface of the flat base 340 and connect through the mounting plate 505 to the support housing 335. Nuts are then tightened onto the studs to secure the device. Optionally the base plate has decorative inserts 510 made of strong, resistant materials for a wide temperature range and water resistance, including but not limited to steel, aluminum, etc.

While holding the two handles, the user looks through the eyepiece at the video screen and is prompted to press a button to begin the software. The video screen then displays a 3D model depicting a modified version of the real, physical world, and as the user moves the OWL head in any direction, the image moves correspondingly, synchronized with the physical characteristics of the outside world to create the illusion of “looking through time” goggles. The user may then press a button and cause the visualization to switch to an alternate view for the purpose of comparing multiple future scenarios. Eventually the visualization ends and a survey loads, prompting the user to respond to a question. The user moves the head to select an answer and presses a button to choose the selected answer and advance to the next question. After the final question is answered, the user may be prompted to record an audio comment. Pressing a button turns on the microphone and the user may record audio, which is saved as a computer file such as an .mp3 file to the computer hard drive. The user experience is then complete and the software resets to the beginning.

In yet another embodiment there are provided at least two new sensors that detect horizontal and vertical rotation of the head. These sensors are connected to the circuit board 415 or computer tablet 420 and when actuated cause the display to feature such a movement. The sensors optionally are located inside the head. Optionally the signal(s) from these sensors override the signal from the accelerometer and gyroscope. Signals from some of this type of sensor can be processed more rapidly than from the accelerometer, causing less latency of response to movement and less drift—and a more realistic experience. The use of absolute position sensors for this task contributes to an improved virtual reality experience. Another improvement is a tension control rod in the central column 325. Such a tension control limits panning to the right or left, movement, and wear and tear. The tension control is adjustable for the desired viewing span.

The present invention is described above with reference to a preferred embodiment. However, those skilled in the art will recognize that changes and modifications may be made in the described embodiment without departing from the nature and scope of the present invention. Various further changes and modifications to the embodiment herein chosen for purposes of illustration will readily occur to those skilled in the art. To the extent that such modifications and variations do not depart from the spirit of the invention, they are intended to be included within the scope thereof.

Reference throughout this specification to an “embodiment,” an “example” or similar language means that a particular feature, structure, characteristic, or combinations thereof described in connection with the embodiment is included in at least one embodiment of the present invention. Thus appearances of the phrases an “embodiment,” and “example,” and similar language throughout this specification may, but do not necessarily, all refer to the same embodiment, to different embodiments, or to one or more of the figures. Additional, reference to the words “embodiment,” “example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where on embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

1. A viewing apparatus comprising
a. a head assembly comprising a back face and a front face, the front face comprising an eyepiece area, buttons and a face lock to secure the front face to the back face;
b. a yoke assembly to support the head assembly, the yoke assembly comprising yoke arms, a yoke base, handle circles, a yoke post, yoke sleeve and post bearings; and
c. a base assembly comprising a base pipe with a top collar fitted into it to attach the yoke assembly, a base step over a lower collar all sitting atop a foot base that sits on a durable surface.

2. The viewing apparatus of claim 1 in which the base step has adjustable supports to level the base step.

3. The viewing apparatus of claim 1 in which the yolk post fits into post bearings that reside in the yoke sleeve.

4. The viewing apparatus of claim 1 in which the head assembly has two holes in its sides to accommodate handles.

5. The viewing apparatus of claim 1 in which the eyepiece area has no lens.

6. The viewing apparatus of claim 1 in which the handles adjust the head to provide panning and tilting.

7. A 3D viewing apparatus comprising
a. a head assembly comprising a back face and a front face, the front face comprising an eyepiece area, buttons and a face lock to secure the front face to the back face;
b. a yoke assembly to support the head assembly, the yoke assembly comprising yoke arms, a yoke base, handle circles, a yoke post, yoke sleeve and post bearings;
c. a base assembly comprising a base pipe with a top collar fitted into it to attach the yoke assembly,
i. a base step over a lower collar all sitting atop a foot base that sits on a durable surface; and
ii. a top step to enable shorter persons to look in the eyepiece; and
d. a custom printed circuit board inside the head, the circuit board interfacing with a set of peripherals and with a computer.

8. The 3D viewing apparatus of claim 7 wherein the peripherals comprise a microphone, a speaker, a sensor, a video display, a plurality of owl lights, or a combination thereof.

9. The 3D viewing apparatus of claim 7 further comprising at least one handle.

10. The handle of claim 9 comprising a handle axle, at least one trigger, at least one underlying trigger switch to convey impulses to the computer and/or circuit board.

11. The handle of claim 9 further comprising a trigger cover to protect the trigger and trigger switch from the elements.

12. A method of viewing a future development in 3D the method comprising
a. providing 3D viewing apparatus comprising
i. a head assembly comprising a back face and a front face, the front face comprising an eyepiece area, buttons and a face lock to secure the front face to the back face;
ii. a yoke assembly to support the head assembly, the yoke assembly comprising yoke arms, a yoke base, handle circles, a yoke post, yoke sleeve and post bearings;
iii. a base assembly comprising a base pipe with a top collar fitted into it to attach the yoke assembly,
iv. a base step over a lower collar all sitting atop a foot base that sits on a durable surface; and
v. a top step to enable shorter persons to look in the eyepiece; and
vi. a custom printed circuit board inside the head, the circuit board interfacing with a set of peripherals and with a computer.
b. loading the computer and/or custom printed circuit board with a set of computerized images of a plurality of planned appearances of a location;
c. setting the viewing apparatus in a location adjacent the location of the future development; and
d. securing the viewing apparatus to a hard surface.
